(19) United States
(12) Patent Application Publication
(10) Pub. No.: US 2019/0020988 A1
(43) Pub. Date: Jan. 17, 2019

(54) VEHICLE COMMUNICATION SYSTEM AND PORTABLE DEVICE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Kenji Matsuoka, Yokkaichi, Mie (JP)

(21) Appl. No.: 16/068,528

(22) PCT Filed: Jan. 23, 2017
(86) PCT No.: PCT/JP2017/002069

§ 371 Date: Jul. 6, 2018

(30) Foreign Application Priority Data
Feb. 11, 2016 (JP) 2016-024249

(51) Int. Cl. H04W 4/48; H04B 17/318; B60R 25/24; G01S 11/06

(52) U.S. Cl. CPC H04W 4/48; H04B 17/318; E05B 81/76; G01S 11/06; B60R 25/24

(57) ABSTRACT

A vehicle communication system includes an onboard device that transmits a detection signal from LF transmission antennas provided in a vehicle, and a portable device that receives the detection signals and transmits a response signal that is in accordance with the received detection signals. The onboard device detects the position of the portable device by receiving the response signal transmitted by the portable device. The portable device includes a measuring unit that measures the received signal strengths of the received detection signals, a quantization unit that quantizes the received signal strengths with a corresponding one of different resolutions, and a transmission unit that transmits a response signal that includes the quantized received signal strength data.

### CROSS-REFERENCE TO RELATED APPLICATIONS

This application is the U.S. national stage of PCT/JP2017/002069 filed Jan. 23, 2017, which claims priority of Japanese Patent Application No. 2016-024249 filed on Feb. 11, 2016, which is incorporated herein by reference in its entirety.

### FIELD OF THE INVENTION

The present description relates to a vehicle communication system and a portable device.

### BACKGROUND OF THE INVENTION

With passive entry systems that are in practical use, vehicle doors can be locked and unlocked without using a mechanical key. A passive entry system is constituted by, for example, a portable device in the possession of a user, a contact sensor that senses that the user gripped a door handle, and an onboard device that detects the position of the portable device when the user grips the door handle, and executes vehicle door lock/unlock processing (e.g., JP 2007-2654A).

If the contact sensor detects that the user gripped a door handle, the onboard device transmits a detection signal for detecting the position of the portable device from multiple LF transmission antennas provided in the vehicle. The portable device receives the detection signals transmitted by the LF transmission antennas, and measures the received signal strengths. Received signal strength data obtained by the measurement is then transmitted by the portable device to the onboard device. The received signal strength data is digital data obtained by quantizing the received signal strengths with a predetermined resolution. The onboard device receives the received signal strength data transmitted by the portable device, and calculates the position of the portable device. If the portable device is located outside of the vehicle, the onboard device executes vehicle door lock/unlock processing.

There is also a Walk Away Closing (WAC) system in which the position of the portable device is detected and tracked after the engine stops, and the vehicle doors are automatically locked if the user in possession of the portable device moves a predetermined distance or more away from the vehicle.

### SUMMARY OF THE INVENTION

A vehicle communication system according to an aspect of the present description is a vehicle communication system including an onboard device that transmits a detection signal from an antenna provided in a vehicle and a portable device that receives the detection signal transmitted by the onboard device and transmits a response signal that is in accordance with the received detection signal, the onboard device detecting a position of the portable device by receiving the response signal transmitted by the portable device, wherein the portable device includes: a measuring unit that measures a received signal strength of the received detection signal; a quantization unit that quantizes the received signal strength measured by the measuring unit with a corresponding one of a plurality of resolutions; and a transmission unit that transmits the response signal that includes received signal strength data obtained by the quantization performed by the quantization unit.

A portable device according to an aspect of the present description is a portable device that receives a detection signal transmitted by an onboard device, and transmits a response signal that is in accordance with the received detection signal, the portable device including: a measuring unit that measures a received signal strength of the received detection signal; a quantization unit that quantizes the received signal strength measured by the measuring unit with a corresponding one of a plurality of resolutions; and a transmission unit that transmits the response signal that includes received signal strength data obtained by the quantization performed by the quantization unit.

Note that the description of the present application can not only be realized as a portable device that includes this characteristic quantization unit, but can also be realized as a vehicle communication method whose steps include this characteristic processing, or be realized as a program for causing a computer to execute these steps. Also, the description can be realized as a vehicle communication system that realizes part of or the entirety of the portable device, or be realized as another system that includes the portable device or the vehicle communication system.

### BRIEF DESCRIPTION OF THE DRAWINGS

FIG. 1 is a schematic diagram showing an example of a configuration of a vehicle communication system.

FIG. 2 is a block diagram showing an example of a configuration of an onboard device.

FIG. 3 is a block diagram showing an example of a configuration of a portable device.

FIG. 4 is a flowchart showing a processing procedure related to vehicle door locking.

FIG. 5 is a flowchart showing a processing procedure related to position detection.

FIG. 6 is a graph showing a relationship between the distance of the portable device from the onboard device and received signal strength data.

FIG. 7 is a graph showing a relationship between received signal strength data before and after conversion.

### DETAILED DESCRIPTION OF THE PREFERRED EMBODIMENTS

In a passive entry system, the position of a portable device in the vicinity of a vehicle needs to be detected with high precision, and therefore there is desire for a relatively high received signal strength to be quantized with a high resolution. On the other hand, in a Walk Away Closing system, it is necessary to detect the position of the portable device when distant from the vehicle, and therefore there is desire for a relatively low received signal strength to be quantized with a required resolution.

However, if the received signal strength resolution is set high in view of prioritizing the specifications of the passive entry system, there is a problem that it is not possible to detect the position of the portable device when distant from the vehicle. If the received signal strength resolution is set in view of prioritizing the specifications of the Walk Away Closing system, there is a problem of saturation of the received signal strength data expressed with a limited number of quantization bits, and thus the position of the portable device when in the vicinity of the vehicle cannot be detected with high precision.

An object of the present disclosure is to provide a vehicle communication system and a portable device that enable the position of the portable device to be detected with a required precision both when the portable device is in the vicinity of a vehicle and when it is distant from the vehicle.

According to the present disclosure, it is possible to provide a vehicle communication system and a portable device that enable the position of the portable device to be detected with a required precision both when the portable device is in the vicinity of a vehicle and when it is distant from the vehicle.

First, embodiments of the present description will be described. Also, at least portions of the embodiments described below may be combined as desired.

(1) A vehicle communication system according to an aspect of the present description is a vehicle communication system including an onboard device that transmits a detection signal from an antenna provided in a vehicle and a portable device that receives the detection signal transmitted by the onboard device and transmits a response signal that is in accordance with the received detection signal, the onboard device detecting a position of the portable device by receiving the response signal transmitted by the portable device, wherein the portable device includes: a measuring unit that measures a received signal strength of the received detection signal; a quantization unit that quantizes the received signal strength measured by the measuring unit with a corresponding one of a plurality of resolutions; and a transmission unit that transmits the response signal that includes received signal strength data obtained by the quantization performed by the quantization unit.

In this aspect, the onboard device detects the position of the portable device relative to the vehicle by performing wireless communication with the portable device. The onboard device transmits the detection signal from the antenna provided in the vehicle, and the portable device measures the received signal strength of the detection signal transmitted by the onboard device. The received signal strength is information that corresponds to the distance of the portable device from the onboard device. The quantization unit of the portable device quantizes the measured received signal strength, and the transmission unit transmits the received signal strength data obtained by the quantization to the portable device. The quantization unit of this aspect in particular quantizes the received signal strength with one of different resolutions, in accordance with the received signal strength. For example, the quantization unit quantizes the received signal strength with different resolutions in the case where the portable device is in the vicinity of the vehicle and the received signal strength is high, and the case where the portable device is distant from the vehicle and the received signal strength is low. Accordingly, the portable device can quantize the received signal strength with a resolution that is suited to the position of the portable device relative to the vehicle in a limited range of quantization bits, and can transmit the received signal strength data quantized in this manner to the onboard device.

(2) A configuration is preferable in which if the received signal strength is lower than a predetermined strength, the quantization unit quantizes the received signal strength with a predetermined first resolution, and if the received signal strength is higher than or equal to the predetermined strength, the quantization unit quantizes the received signal strength with a second resolution that is higher than the first resolution.

In this aspect, in the case where the received signal strength is lower than the predetermined strength, the quantization unit can quantize the received signal strength with the first resolution that is a low resolution, and in the case where the received signal strength is higher than or equal to the predetermined strength, the quantization unit can quantize the received signal strength with the second resolution that is a high resolution, and the received signal strength data quantized in this way can be transmitted to the onboard device.

(3) A configuration is preferable in which the onboard device further includes a conversion unit that converts the received signal strength data included in the received response signal into received signal strength data quantized with a given resolution.

In this aspect, the onboard device can obtain received signal strength data that has been quantized with a given resolution by performing conversion processing on the received signal strength data.

(4) A portable device according to an aspect of the present description is a portable device that receives a detection signal transmitted by an onboard device, and transmits a response signal that is in accordance with the received detection signal, the portable device including: a measuring unit that measures a received signal strength of the received detection signal; a quantization unit that quantizes the received signal strength measured by the measuring unit with a corresponding one of a plurality of resolutions; and a transmission unit that transmits the response signal that includes received signal strength data obtained by the quantization performed by the quantization unit.

In this aspect, similarly to aspect (1), the portable device can quantize the received signal strength with a resolution that is suited to the position of the portable device relative to the vehicle in a limited range of quantization bits, and can transmit the received signal strength data quantized in this manner to the onboard device.

Specific examples of an onboard device and a vehicle communication system according to embodiments of the present description will be described below with reference to the drawings. Note that the present description is not limited to these examples, but rather is indicated by the scope of the claims, and all changes that come within the meaning and range of equivalence of the claims are intended to be embraced therein.

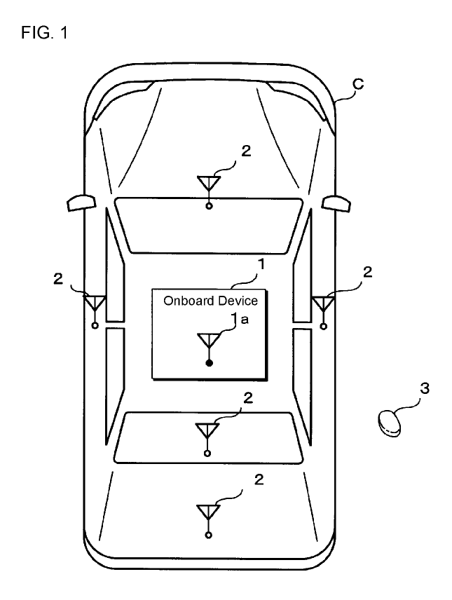

FIG. 1 is a schematic diagram showing an example of the configuration of a vehicle communication system. The vehicle communication system of the present embodiment includes an onboard device 1 that transmits and receives various signals with use of multiple LF transmission antennas 2 and an RF reception antenna 1a provided in a vehicle C, and a portable device 3 that exchanges the aforementioned signals with the onboard device 1. The onboard device 1 detects the position of the portable device 3 relative to the vehicle C, and executes vehicle door lock/unlock processing. The LF transmission antennas 2 are provided on the driver-side and passenger-side pillars, in front and rear portions inside the vehicle, on the back door, and the like, and transmit signals using LF-band radio waves. Note that the LF band is one example of the radio wave band for transmitting signals, and the present description is not necessarily limited to this example. Note that a detection signal for detecting the position of the portable device 3 is generally transmitted from all of the LF transmission antennas 2. The following description uses the example where the detection signal is transmitted from all of the LF transmission antennas 2, but a configuration in which the detection signal is transmitted from two or more LF transmission antennas 2 depending on the situation is not excluded from the present description.

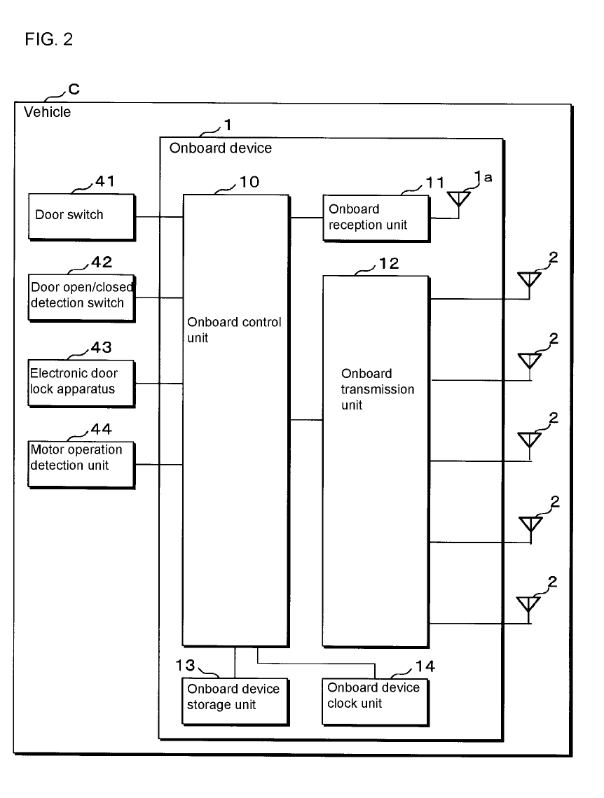

FIG. 2 is a block diagram showing an example of the configuration of the onboard device 1. The onboard device 1 includes an onboard control unit 10 that controls the operation of constituent units of the onboard device 1. The onboard control unit 10 is a microcontroller that has one or more CPUs (Central Processing Units), a multicore CPU, or the like. The onboard control unit 10 is provided with an onboard reception unit 11, an onboard transmission unit 12, an onboard device storage unit 13, and an onboard device clock unit 14.

By executing a later-described control program stored in the onboard device storage unit 13, the onboard control unit 10 controls the operation of constituent units, detects the position of the portable device 3 relative to the vehicle C, and executes lock/unlock processing in accordance with the position of the portable device 3.

The onboard device storage unit 13 is a nonvolatile memory such as an EEPROM (Electrically Erasable Programmable ROM) or a flash memory. The onboard device storage unit 13 stores a control program according to which the onboard control unit 10 controls constituent units of the onboard device 1 in order to specify the position of the portable device 3 relative to the vehicle C and perform vehicle door lock/unlock processing.

The onboard reception unit 11 is connected to the RF reception antenna la, receives various signals such as a response signal transmitted by the portable device 3 using UHF-band radio waves, and outputs the received signals to the onboard control unit 10. Communication employing UHF-band radio waves can be performed over a large region, and therefore there are no particular limitations on the arrangement of the RF reception antenna 1a in the vehicle C.

The onboard transmission unit 12 is connected to the LF transmission antennas 2, and transmits the detection signal for detecting the position of the portable device 3 under control of the onboard control unit 10. The strengths of the detection signals transmitted from the LF transmission antennas 2 are set such that the portable device 3 can receive detection signals transmitted from two or more LF transmission antennas 2 when inside the vehicle and outside the vehicle.

The onboard device clock unit 14 starts measuring time under control of the onboard control unit 10, and gives timing results to the onboard control unit 10.

A door switch 41 that is for locking/unlocking the vehicle door from outside the vehicle is connected to the onboard control unit 10, and a door signal that corresponds to the operation state of the door switch 41 is input to the onboard control unit 10. The onboard control unit 10 can recognize the operation state of the vehicle door based on the door signal from the door switch 41. The door switch 41 is a request switch for locking/unlocking the driver-side vehicle door, and is provided in the outside driver-side door handle, for example. Note that instead of the push-button type of request switch, a contact sensor that detects contact between the user and the door handle may be provided. Also, the onboard control unit 10 may directly acquire the door signal that corresponds to operation of the door switch 41, or may acquire the door signal via an ECU (Electronic Control Unit) or the like.

Also, a door open/closed detection switch 42 that detects the opening and closing of the vehicle door is connected to the onboard control unit 10. The door open/closed detection switch 42 is a courtesy switch that turns on or off according to the opening or closing of the vehicle door, and is configured to input to the onboard control unit 10 an open/closed signal that corresponds to the on or off state, for example.

Furthermore, an electronic door lock apparatus 43 and a motor operation detection unit 44 are connected to the onboard control unit 10.The electronic door lock apparatus 43 includes a lock mechanism that locks and unlocks a corresponding vehicle door, and an actuator that drives the lock mechanism. The electronic door lock apparatus 43 locks and unlocks the vehicle door by driving the actuator under control of the onboard control unit 10. The motor operation detection unit 44 is an ignition switch, and is configured to input, to the onboard control unit 10, a signal that corresponds to the operation position of the ignition switch, for example. The onboard control unit 10 can recognize whether or not the motor is in operation based on the signal that corresponds to the operation position of the ignition switch. Note that the in-operation state of the motor of the present application includes a state of being temporarily stopped through an idling stop function. Also, in the case where a smart start system is provided in the vehicle C, a configuration is possible in which the operation state of the motor is recognized based on a received signal related to the operation state of the motor, which is in accordance with operation of a smart start button.

Note that FIG. 2 shows an aspect in which the door switch 41, the door open/closed detection switch 42, the electronic door lock apparatus 43, and the motor operation detection unit 44 are directly connected to the onboard control unit 10, and these various switches and apparatuses may be directly connected by signal lines, may be connected via an onboard communication network such as a CAN or a LIN, or may be connected via another ECU.

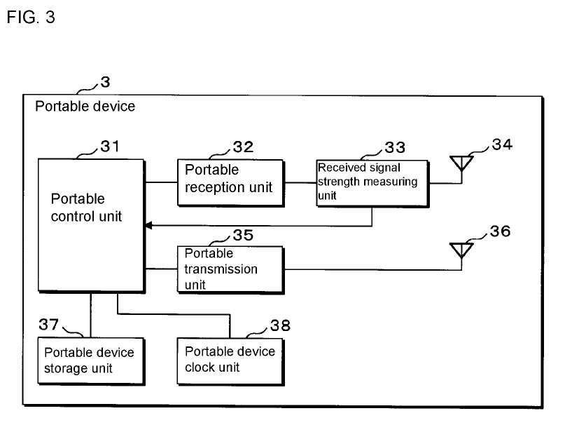

FIG. 3 is a block diagram showing an example of the configuration of the portable device 3. The portable device 3 includes a portable control unit 31 that controls the operation of constituent units of the portable device 3. The portable control unit 31 is a microcontroller that includes one or more CPUs, a multicore CPU, or the like. The portable control unit 31 is provided with a portable reception unit 32, a portable transmission unit (transmission unit) 35, a portable device storage unit 37, and a portable device clock unit 38.

By reading out a later-described control program stored in the portable device storage unit 37 and controlling the operation of constituent units, the portable control unit 31 executes processing for controlling the operation of the constituent units and transmitting, to the onboard device 1, information that is necessary for detecting the position of the portable device 3 relative to the vehicle C.

The portable device storage unit 37 is a nonvolatile memory similar to the onboard device storage unit 13. The portable device storage unit 37 stores a control program according to which the portable control unit 31 controls constituent units of the portable device 3 in order to transmit, to the onboard device 1, a response signal that includes information necessary for detecting the position of the portable device 3 relative to the vehicle C, for example.

The portable reception unit 32 is connected to an LF reception antenna 34 via a received signal strength measuring unit (measuring unit) 33, and receives various types of signals transmitted by the onboard device 1 using LF-band radio waves, and outputs various types of signals to the portable control unit 31. The LF reception antenna 34 is a three-axis antenna for example, and a given received signal strength is obtained regardless of the direction or orientation of the portable device 3 relative to the vehicle C.

The received signal strength measuring unit 33 is a circuit that detects the received signal strength of a detection signal received by the LF reception antenna 34, and outputs the detected received signal strength to the portable control unit 31.

The portable transmission unit 35 is connected to an RF transmission antenna 36, and transmits a response signal that is in accordance with the detection signals transmitted by the onboard device 1, under control of the portable control unit 31. The portable transmission unit 35 transmits the response signal using UHF-band radio waves. Note that the UHF band is one example of the radio wave band for transmitting signals, and the present description is not necessarily limited to this example.

The portable device clock unit 38 starts measuring time under control of the portable control unit 31, and gives timing results to the portable control unit 31.

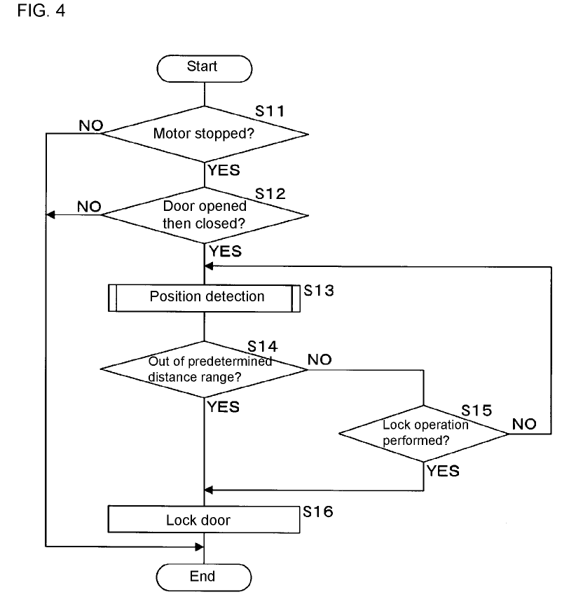

FIG. 4 is a flowchart showing a processing procedure related to vehicle door locking. The onboard control unit 10 detects the operation state of the motor with use of the motor operation detection unit 44, and determines whether or not the motor is stopped (step S11). Upon determining that the motor is not stopped (step S11:NO), the onboard control unit 10 ends this processing.

Upon determining that the motor is stopped (step S11:YES), the onboard control unit 10 determines whether or not the vehicle door was opened and closed with use of the door open/close detection switch 42 (step S12). The opening and closing of the door in this determination is a state in which the closed vehicle door is opened and then closed again. In other words, the onboard control unit 10 detects that the driver has exited the vehicle based on the opening and closing of the door. Upon determining that the vehicle door has not been opened and closed (step S12:NO), the onboard control unit 10 ends this processing.

Upon determining that the vehicle door was opened and closed (step S12:YES), the onboard control unit 10 detects the position of the portable device 3 (step S13). Details of processing for detecting the position of the portable device 3 will be described later.

The onboard control unit 10 then determines whether or not the portable device 3 is outside a predetermined distance range centered on the vehicle C (step S14). Upon determining that the portable device 3 is outside the predetermined distance range (step S14:YES), the onboard control unit 10 locks the vehicle door (step S16) by outputting, to the electronic door lock apparatus 43, a lock instruction signal that instructs the locking of the vehicle door, and then ends this processing.

Upon determining that the portable device 3 is in the predetermined distance range (step S14:NO), the onboard control unit 10 determines whether or not a lock operation was performed with use of the door switch 41 (step S15). Upon determining that the lock operation has not been performed (step S15:NO), the onboard control unit 10 returns the processing to step S13. Upon determining that the lock operation was performed (step S15:YES), the onboard control unit 10 locks the vehicle door (step S16) by outputting, to the electronic door lock apparatus 43, the lock instruction signal that instructs the locking of the vehicle door, and then ends this processing. Note that when actually locking the vehicle door, position detection and authentication processing are performed with respect to the portable device 3 here as well, and if it is determined that an authorized portable device is outside the vehicle and in the vicinity of the operated door switch 41, the onboard control unit 10 outputs the lock instruction signal.

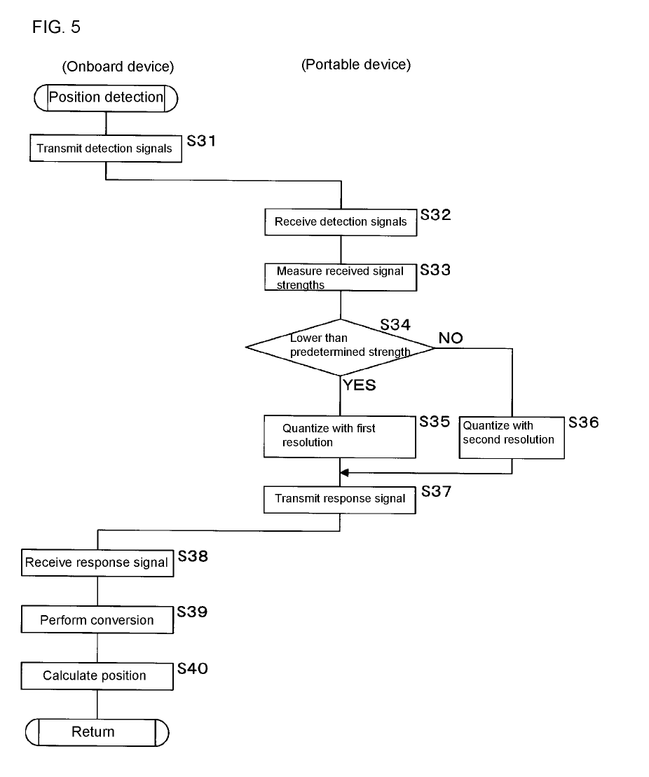

FIG. 5 is a flowchart showing a processing procedure related to position detection. In step S13, the onboard control unit 10 executes the following processing related to the detection of the position of the portable device 3. First, the onboard control unit 10 transmits the detection signal from each of the LF transmission antennas 2 (step S31).

The portable control unit 31 receives, with use of the LF reception antenna 34, the detection signals transmitted by the LF transmission antennas 2 (step S32), and measures the received signal strengths of the received detection signals with use of the received signal strength measuring unit 33 (step S33).

The portable control unit 31 then determines whether or not the received signal strengths are less than a predetermined strength (step S34). In the case where it is determined that a received signal strength is less than the predetermined strength (step S34:YES), the received signal strength is quantized with a predetermined first resolution (step S35). In the case where it is determined that a received signal strength is higher than or equal to the predetermined strength (step S34:NO), the portable control unit 31 quantizes the received signal strength with a second resolution (step S36).

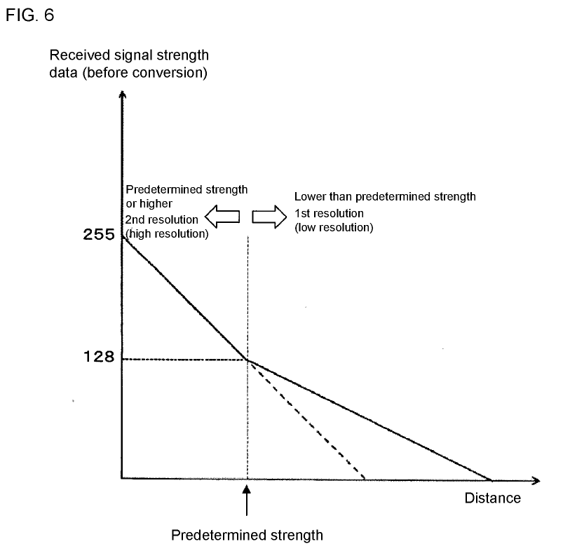

FIG. 6 is a graph showing the relationship between the distance of the portable device 3 from the onboard device 1 and received signal strength data. In the graph shown in FIG. 6, the horizontal axis indicates distance, and the vertical axis indicates the value of received signal strength data before conversion. Note that the received signal strength decreases as the distance increases. As one example here, it is assumed that the number of quantization bits is 8. The predetermined strength is a value corresponding to (first resolution×128), for example. The portable control unit 31 quantizes the portion of received signal strengths that are lower than the predetermined strength with use of the first resolution, and quantizes the portion of received signal strengths that are higher than or equal to the predetermined strength with use of the second resolution. The first and second resolutions indicate a received signal strength per bit, and it is assumed that the second resolution is higher than the first resolution. Note that the solid line indicates the relationship between the received signal strength data and the distance in the case where quantization is performed using different resolutions according to the received signal strength, and the dashed line indicates the relationship between the received signal strength data and the distance in the case where quantization is performed using a given resolution.

More specifically, in the case where the received signal strength is lower than the predetermined strength, received signal strength data Rd is expressed by Expression (1) below.

Rd=R/ΔLOW (1)

Note that:

R: received signal strength

ΔLOW: first resolution (received signal strength per bit)

In the case where a received signal strength is higher than or equal to the predetermined strength, the received signal strength data Rd is expressed by Expression (2) below.

Rd=(R−R0)/ΔHIGH+R0/ΔLOW (2)

Note that:

R0: predetermined strength

ΔHIGH: second resolution (received signal strength per bit)<ΔLOW

As shown in FIG. 6, the first resolution is a low resolution, and the second resolution is a high resolution. For this reason, even if the number of quantization bits that express the received signal strength data is limited, as shown in FIG. 6, it is possible to express a small received signal strength of a signal received by the portable device 3 when distant from the vehicle C, and moreover a large received signal strength detected when at a short distance from the vehicle C can be expressed with a high resolution without saturation.

Note that the onboard control unit 10 that executes step S35 and step S36 corresponds to the quantization unit of the present aspect.

Next, the portable control unit 31 transmits a response signal that includes the quantized received signal strength data to the onboard device 1 with use of the RF transmission antenna 36 (step S37). The response signal includes received signal strength data that corresponds to each of the detection signals transmitted by the LF transmission antennas 2.

The onboard control unit 10 receives the response signal transmitted by the portable device 3, with use of the RF reception antenna 1a (step S38). The onboard control unit 10 then converts the received signal strength data included in the received response signal into received signal strength data that is quantized with a certain resolution (step S39). For example, the received data is converted into received signal strength data that is quantized with the second resolution. The response signal includes multiple pieces of received signal strength data, and the onboard control unit 10 executes conversion processing for each piece of received signal strength data.

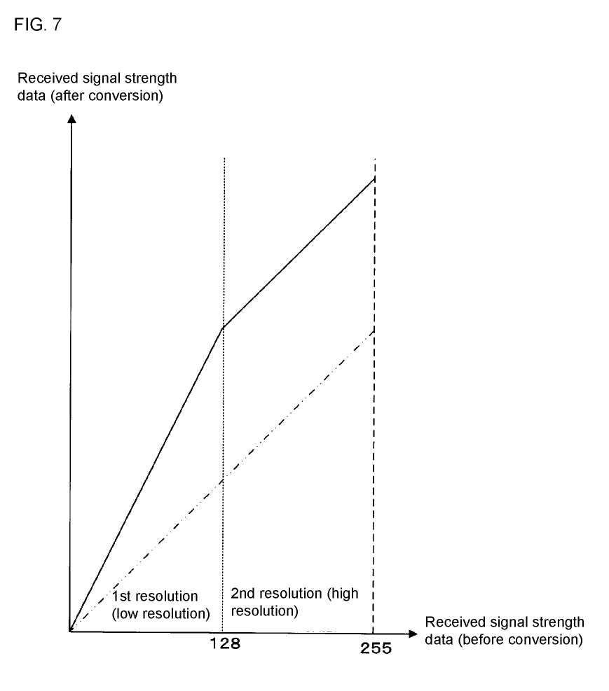

FIG. 7 is a graph showing a relationship between received signal strength data before and after conversion. In the graph shown in FIG. 7, the horizontal axis indicates the value of received signal strength data before conversion, and the vertical axis indicates the value of received signal strength data after conversion. The dashed double-dotted line shows the relationship between data in the case where conversion is not performed.

Specifically, in the case where the received signal strength data is lower than a predetermined value that corresponds to a predetermined strength, conversion of the received signal strength data Rd that was converted with the second resolution is expressed by Expression (3) below. The predetermined value is 128, for example.

Rd conversion=Rd×ΔLOW/ΔHIGH (3)

In the case where the received signal strength data is higher than or equal to the predetermined value, conversion of the received signal strength data Rd that was converted with the second resolution is expressed by Expression (4) below.

Rd conversion=predetermined value×ΔLOW/ΔHIGH+(Rd−predetermined value) (4)

According to this conversion processing, the received signal strengths can be expressed with the given second resolution. Of course, the value of the resolution used in conversion is not limited to being the second resolution, and conversion can be performed with a desired resolution. Note that the onboard control unit 10 that executes the processing of step S39 corresponds to the conversion unit of the present aspect.

In the case where the number of quantization bits is 8, and the predetermined value is 128, it is sufficient that the onboard control unit 10 performs conversion using Expression (3) when the most significant bit is 0, and performs conversion using Expression (4) when the most significant bit is 1. Note that the value of (Rd−predetermined value) is a numerical value expressed by the 7 lower bits other than the most significant bit.

Next, the onboard control unit 10 calculates the position of the portable device 3 using the pieces of received signal strength data expressed with the second resolution (step S40), and then returns the processing to step S14. The value of each piece of received signal strength data corresponds to the distance between the portable device 3 and the corresponding LF transmission antenna 2, and the onboard control unit 10 calculates, as the position of the portable device 3, the position that achieves consistency in the relationships with the distance between the portable device 3 and the respective LF transmission antennas 2.

According to the vehicle communication system and the portable device 3 having the above configurations, the position of the portable device 3 can be detected with a required precision both when the portable device 3 is in the vicinity of the vehicle and when it is distant from the vehicle.

Specifically, if the received signal strength is lower than the predetermined strength, the portable device 3 can quantize the received signal strength with the first resolution that is a low resolution, and if the received signal strength is higher than or equal to the predetermined strength, the portable device 3 can quantize the received signal strength with the second resolution that is a high resolution, and therefore can transmit, to the onboard device 1, received signal strength data that has been quantized with two different resolutions. Accordingly, the onboard device 1 can detect the position of the portable device 3 with a high resolution when the portable device 3 is in the vicinity of the vehicle, and can also detect the position of the portable device 3 when distant from the vehicle.

Also, the onboard device 1 receives pieces of received signal strength data that correspond to the detection signals transmitted by the respective LF transmission antennas 2, and because the positional relationship between the portable device 3 and the LF transmission antenna 2 is different for each LF transmission antenna 2, there are cases where the resolutions of the received pieces of received signal strength data are different from each other. However, according to the present embodiment, the pieces of received signal strength data can be converted into received signal strength data that is expressed with the same resolution. Accordingly, the pieces of received signal strength data can be handled in the same way in the subsequently performed processing for calculating the position of the portable device 3.

Note that although the example where the received signal strengths are quantized with the first resolution or the second resolution according to the strength is described in the present embodiment, a configuration is possible in which the received signal strengths are quantized with use of three or more resolutions that correspond to the strength. Also, although the case where the number of quantization bits is 8 bits is described, this is of course one example, and there are no particular limitations on the number of quantization bits.

Also, although the case where the present description is mainly applied to a Walk Away Closing system is described in the present embodiment, the present description can be applied to various types of systems that need to detect the position of the portable device 3 when in the vicinity of the vehicle and when distant from the vehicle.

### LIST OF REFERENCE NUMERALS

1 Onboard device

1a RF reception antenna

2 LF transmission antenna

3 Portable device

10 Onboard control unit

11 Onboard reception unit

12 Onboard transmission unit

13 Onboard device storage unit

14 Onboard device clock unit

31 Portable control unit

32 Portable reception unit

33 Received signal strength measuring unit

34 LF reception antenna

35 Portable transmission unit

36 RF transmission antenna

37 Portable device storage unit

38 Portable device clock unit

41 Door switch

42 Door open/closed detection switch

43 Electronic door lock apparatus

44 Motor operation detection unit

C Vehicle

1. A vehicle communication system comprising an onboard device that transmits a detection signal from an antenna provided in a vehicle and a portable device that receives the detection signal transmitted by the onboard device and transmits a response signal that is in accordance with the received detection signal, the onboard device detecting a position of the portable device by receiving the response signal transmitted by the portable device,
wherein the portable device comprises:
a measuring unit that measures a received signal strength of the received detection signal;
a quantization unit that quantizes the received signal strength measured by the measuring unit with a corresponding one of a plurality of resolutions; and
a transmission unit that transmits the response signal that includes received signal strength data obtained by the quantization performed by the quantization unit.

2. The vehicle communication system according to claim 1, wherein if the received signal strength is lower than a predetermined strength, the quantization unit quantizes the received signal strength with a predetermined first resolution, and if the received signal strength is higher than or equal to the predetermined strength, the quantization unit quantizes the received signal strength with a second resolution that is higher than the first resolution.

3. The vehicle communication system according to claim 1, wherein the onboard device further comprises a conversion unit that converts the received signal strength data included in the received response signal into received signal strength data quantized with a given resolution.

4. A portable device that receives a detection signal transmitted by an onboard device, and transmits a response signal that is in accordance with the received detection signal, the portable device comprising:
a measuring unit that measures a received signal strength of the received detection signal;
a quantization unit that quantizes the received signal strength measured by the measuring unit with a corresponding one of a plurality of resolutions; and
a transmission unit that transmits the response signal that includes received signal strength data obtained by the quantization performed by the quantization unit.
